(19) United States
(12) Patent Application Publication
(10) Pub. No.: US 2004/0062189 A1
(43) Pub. Date: Apr. 1, 2004

(54) Information storage medium

(75) Inventors: Makoto Matsukawa, Yamanashi-ken (JP); Seiro Oshima, Yamanashi-ken (JP); Takao Tagiri, Yamanashi-ken (JP); Kiyoshi Nagasawa, Yamanashi-ken (JP); Toshihiko Takishita, Yamanashi-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Pioneer Corporation

(21) Appl. No.: 10/631,857

(22) Filed: Aug. 1, 2003

(30) Foreign Application Priority Data
Aug. 30, 2002 (JP) 2002-253563

(51) Int. Cl. G11B 7/24

(52) U.S. Cl. 369/275.4; 430/270.13

(57) ABSTRACT

A phase change type information storage medium is provided, which achieves high-speed recording/reproduction. A DVD-RW disc having a substrate formed with grooves, lands, and land pre-pits, on which are laminated a first dielectric layer, a phase-change recording layer, a second dielectric layer, a reflective layer, and an overcoat layer. The disc is rotated at a 3.49-7.0 m/sec linear speed while being irradiated with a laser beam of 600-700 nm wavelength focused by an objective lens of 0.55-0.7 numerical aperture to the phase-change recording layer from the substrate side. The phase-change recording layer is made of a Ge-In-Sb-Te material, and the reflective layer is made of an Ag-Nd-Cu material. The first dielectric layer has a 65-85 nm thickness, the phase-change recording layer has a 10-20 nm thickness, the second dielectric layer has a 13-23 nm thickness, and the reflective layer has a 100-225 nm thickness. The grooves have a 200-350 nm width and 25-50 nm depth, and the land pre-pits have a depth of plus-minus 3 nm relative to the groove depth.

### BACKGROUND OF THE INVENTION

The present invention relates to a rewritable information storage medium, and particularly to a phase-change type information storage medium that allows high-speed recording and reproduction of information.

The present application claims priority from Japanese Application No.2002-253563, the disclosure of which is incorporated herein by reference.

DVD-RW, which allows information to be recorded, erased, and overwritten or rewritten using a phase change technology, and to be read based on light reflection, has attracted attention as a rewritable large-capacity information storage medium.

A DVD-RW disc includes a recording layer that is generally formed of a chalcogenide phase change material such as Ge-Te-Sb. Writing, erasing, and rewriting may be achieved by making use of phase change characteristics of this recording layer, i.e., heating the recording layer at a temperature higher than the melting point with a high power laser beam and cooling it down to change the layer into an amorphous state, while heating the layer at a temperature lower than the melting point with a low power laser beam and cooling it down to return the layer into the crystalline state.

In an information read/write device, the laser beam power is controlled based on a preset power strategy so that recording marks of the amorphous state are formed in the recording layer to write and rewrite information, and that the recording marks formed in the recording layer are returned to the crystalline state to erase the recorded information.

For reproducing the information, a laser beam of even lower power than the aforementioned low power laser beam is irradiated to the recording layer. The reflection light of this laser beam is indicative of the locations of the marks because of the difference in the reflectivity between amorphous and crystal portions. Information is thus reproduced by signal processing of this reflection light performed in the information read/write device, thereby achieving the reproduction by means of light reflection system.

DVD-RW discs are fabricated according to a certain physical format and logical format to satisfy the requirements specified by the DVD-RW Version 1.1 standard.

One example of the physical format is spiral guide grooves which correspond to the recording layer and are pre-molded on the substrate on the laser incident side; highly precise tracking control is achieved based on reflection light reflected from lands and grooves forming the spiral grooves.

The groove is a wobble groove formed in a meandering pattern in a constant cycle with pre-pits in lands; the reflection light from the wobble and land pre-pits enables constant rotation speed (linear speed) control of the DVD-RW disc during the recording and provides recording clock and address information, and the like.

With the increase in capacity, demands are rising in the field of phase-change type information storage medium such as the above DVD-RW disc for reducing necessary processing time in recording and reproducing information, i.e., for faster recording, erasing, and reproducing of information.

Simply increasing the linear speed on the side of the information read/write device cannot ensure stable phase change of the recording layer for writing and erasing, and may cause noise or distortion in reproduced signals when reproducing information. Thus, realization of a phase-change type information storage medium having a novel structure that can speed up the writing, reading, and erasing without causing deterioration in precision is much awaited.

### SUMMARY OF THE INVENTION

The present invention has been devised in view of the above problems in prior art, and an object of the invention is to provide a phase-change type information storage medium having a novel structure for enabling high-speed recording and reproduction of information.

To achieve the above object, the present invention provides an information storage medium including a substrate having grooves, lands formed between the grooves, and land pre-pits formed in the lands, which are formed on one side thereof; and a first dielectric layer, a phase-change recording layer, a second dielectric layer, and a reflective layer formed in order on this side of the substrate. The information storage medium is rotated at a linear speed ranging from 3.49 to 7.0 m/sec while the phase-change recording layer in the grooves is irradiated with a 600 to 700 nm wavelength laser beam through an objective lens having a numerical aperture ranging from 0.55 to 0.7, thereby effecting the information recording and reproduction. The phase-change recording layer is made of a Ge-In-Sb-Te material, while the reflective layer is made of an Ag-Nd-Cu material. The first dielectric layer has a thickness ranging from 65 to 85 nm, the phase-change recording layer has a thickness ranging from 10 to 20 nm, the second dielectric layer has a thickness ranging from 13 to 23 nm, and the reflective layer has a thickness ranging from 100 to 225 nm. The grooves have a width ranging from 200 to 350 nm and a depth ranging from 25 to 50 nm, while the land pre-pits have a depth in a range of plus-minus 3 nm relative to the depth of the grooves.

### BRIEF DESCRIPTION OF THE DRAWINGS

These and other objects and advantages of the present invention will become clear from the following description with reference to the accompanying drawings, wherein:

FIG. 1 is a model view of a longitudinal cross section of a DVD-RW disc according to one embodiment of the invention;

FIG. 2 a model view of a longitudinal cross section of the DVD-RW disc according to one example;

FIG. 3 is a view illustrating a fabrication process step of the DVD-RW disc according to one example;

FIGS. 4A to 4C illustrate the structure of the lands, grooves, and land pre-pits of the DVD-RW disc, FIG. 4A being a microscope image of a cross section along the line A-A of FIG. 4C, and FIG. 4B being a cross section along the line A-A of FIG. 4C;

FIG. 5 is a graph showing the characteristics of the DVD-RW disc according to one example, by plotting the number of PI errors versus the difference in the groove depth and land pre-pits depth;

FIG. 6 shows the relationship between the difference in the groove depth and land pre-pits depth and the number of PI errors in the DVD-RW disc according to one example;

FIGS. 7A to 7C are images given in explanation of problems resulting from the difference in the groove depth and land pre-pits depth; and

FIGS. 8A and 8B show test results of overall evaluation of the DVD-RW disc.

### DETAILED DESCRIPTION OF THE PREFERRED EMBODIMENTS

Preferred embodiments of the present invention will be hereinafter described with reference to the accompanying drawings. One preferred embodiment of the invention is a phase-change type information storage medium that is compatible with the existing DVD-RW Version 1.1 standard and capable of high-precision, high-speed recording, reproduction, and erasing of information (hereinafter “DVD-RW disc”).

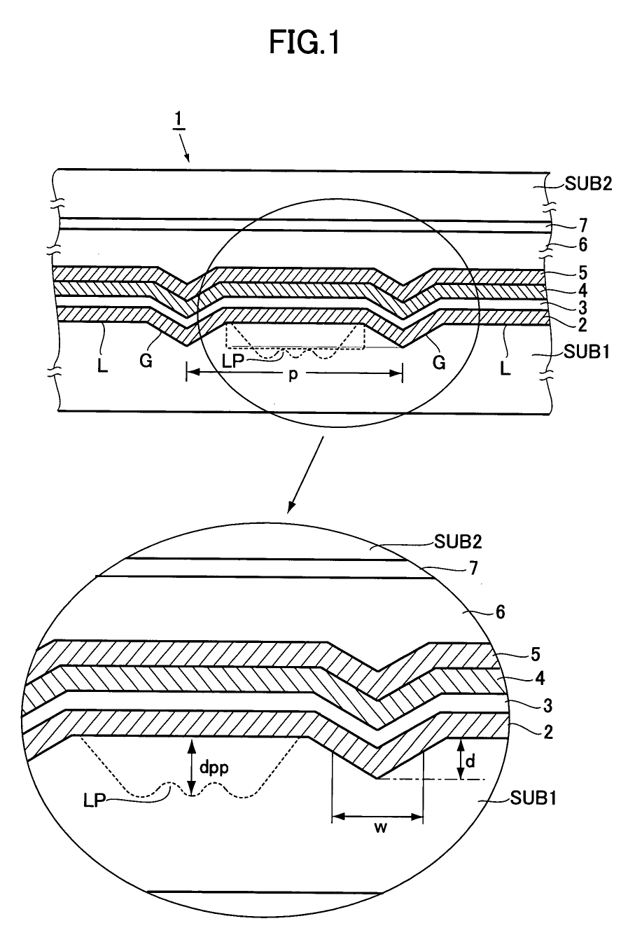

FIG. 1 is a model view of a partial, longitudinal cross section of a DVD-RW disc 1 cut along a radial direction.

The disc 1 has a first substrate SUB1 which is transparent to laser light as will be described later, and a second substrate SUB2 on the backside of the first substrate. Between the two substrates SUB1 and SUB2 are interposed a first dielectric layer 2, a phase-change recording layer 3, a second dielectric layer 4, a reflective layer 5, an overcoat layer 6, and an adhesive layer 7.

More specifically, on one side of the first substrate SUB1 are formed spiral or concentric grooves G and lands L around the so-called clamp hole at the center of the DVD-RW disc 1. The grooves G are formed in a meandering pattern in a constant cycle along the circumference. In the lands L are formed land pre-pits LP that provide the pre-address information and disc code or the like.

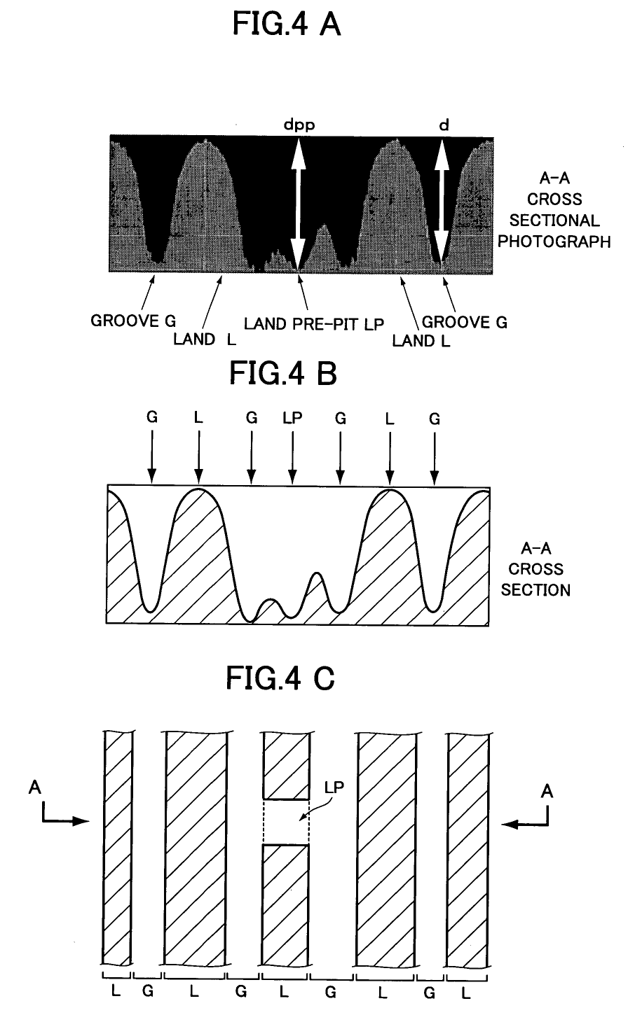

Land pre-pits LP are formed in the spiral or concentric lands L along the length with preset spacing independently of the lands L. The structure of the lands L and land pre-pits LP will be described later in detail with reference to FIG. 4.

Upon this land-groove structure on one side of the first substrate SUB1 are stacked the first dielectric layer 2, phase-change recording layer 3, second dielectric layer 4, and reflective layer 5 in this order. The overcoat layer 6 is further laminated and the second substrate SUB2 is bonded thereon with the adhesive layer 7.

The first dielectric layer 2 to the adhesive layer 7 of the DVD-RW disc 1 are thus held between the two substrates SUB1 and SUB2 and united, forming a sandwich structure.

On the main surface of the substrate SUB1, the formed lands L are either spiral or concentric, and the grooves G are concave relative to the lands L, across section of the grooves being V-shaped.

The substrate SUB1 is formed of a transparent glass or resin material having a transparency of 85% or more with low optical anisotropy relative to laser beam described later. Resin materials that can typically be used for the substrate are thermoplastic resins such as acrylic resins, polycarbonate resins, and polyolefin resins. Of these, polycarbonate resins are particularly preferable in respect of the mechanical strength of the disc DVD-RW disc 1 and moldability of the land-groove structure on the substrate SUB1.

The substrate SUB1 has a thickness ranging from 0.57 to 0.63 mm, the depth d of the grooves G being in the range of from 25 to 50 nm, and the width w at a depth d/2 of the grooves being in the range of from 200 to 350 nm. The track pitch p, or the spacing between the land L and groove G, is in the range of from 0.7 to 0.8 μm.

The land pre-pits LP in the lands L have a depth dpp ranging from −3 to 3 nm relative to the depth d of the grooves G. That is, the depth dpp (unit: nm) of the land pre-pits LP satisfies dg−3≦dpp≦dg+3, where dg (unit: nm) is a value in the aforementioned range of 25 to 50 nm of the groove depth d.

The first dielectric layer 2 is formed of a material that is transparent to laser light and dielectric and has a high thermal conductivity. Its thickness is in the range of from 65 to 85 nm. The first dielectric layer 2 functions as a protective layer for the phase-change recording layer 3, as well as adjusts the optical and thermal characteristics of the phase-change recording layer 3. In particular, the first dielectric layer 2 enhances heat dissipation efficiency of the phase-change recording layer 3 when changing into amorphous or crystalline state to record or erase information.

The phase-change recording layer 3 is made of a phase-changeable material having a composition that has a high crystallization speed and erasability and is stable both in crystalline and amorphous states, such as a Ge-In-Sb-Te material, which satisfies these requirements. The layer thickness is set in the range of from 10 to 20 nm.

The second dielectric layer 4 is formed of a material that is transparent to laser light and dielectric and has a high thermal conductivity. Its thickness is in the range of from 13 to 23 nm. The second dielectric layer 4 functions as a protective layer for the phase-change recording layer 3, as well as adjusts the optical and thermal characteristics of the phase-change recording layer 3. In particular, the second dielectric layer 4 enhances heat dissipation efficiency of the phase-change recording layer 3 when changing into amorphous or crystalline state to record or erase information.

The reflective layer 5 is made of an Ag-Nd-Cu metal material having a high reflectivity to laser light and high thermal conductivity, and has a thickness in the range of from 100 to 225 nm.

The overcoat layer 6 is formed by spin-coating UV-setting resin on the reflective layer 5 and curing it by UV irradiation to a thickness of about 1 to 250 μm.

The adhesive for the adhesive layer 7 is, e.g., a UV-setting, organic material.

The second substrate SUB2 is formed of a thermoplastic resin such as an acrylic, polycarbonate, or polyolefin resin, and provided mainly for maintaining the mechanical strength of the DVD-RW disc 1.

The DVD-RW disc 1 thus constructed is rotated at an rpm or linear speed ranging from 3.49 to 7.0 m/sec in the information read/write device. A laser beam of wavelength 600 to 700 nm irradiated from a built-in semiconductor laser is focused by an objective lens having a numerical aperture of 0.55 to 0.70, and the focused laser beam is directed to the first substrate SUB1 to achieve recording and erasing, or reproduction, of information.

For the recording of information, a high power laser beam is irradiated under the above conditions of rpm, wavelength, and numerical aperture of the objective lens in accordance with a preset power strategy. Irradiated portions of the phase-change recording layer 3 change into the amorphous state when heated to above the melting point and cooled, thus forming recording marks.

For the erasing of information, a lower power laser beam than that for the information recording is irradiated in accordance with the power strategy to heat the recording marks in the amorphous state to below the melting point. The irradiated portions return to the crystalline state when cooled down, thus erasing the information.

For the reproduction of information, a laser beam of even lower power is irradiated in accordance with the power strategy to the phase-change recording layer 3. The difference in reflectivity of amorphous and crystalline portions causes a change in reflected light intensity, indicating locations of recorded marks. The information read/write device performs signal processing of this reflected light to reproduce information.

The DVD-RW disc 1 of this invention is compatible with the existing DVD-RW Version 1.1 standard and information can be read, written, and erased at normal speed (3.49 m/sec). Reading, writing, and erasing are also possible at more than normal speed and up to double speed (7.0 m/sec). Further, the following effects are achieved.

By adopting a Ge-In-Sb-Te material for the phase-change recording layer 3, the crystallization speed is enhanced, and stabilization of both amorphous and crystalline states is achieved, which all lead to higher-speed, higher-precision recording/reproduction/erasure.

The higher crystallization speed means better crystallizability of the phase-change recording layer 3, which is essential for higher recording/reproduction/erasure. This requirement is also important so as not to cause a situation in which part of amorphous recording marks remain uncrystallized. Stabilization of crystalline and amorphous states is also essential.

A Ge-In-Sb-Te material enhances the crystallization speed, and while it can have a composition having high erasability, it is stable in both crystalline and amorphous states, satisfying all the above requirements. The phase-change recording layer 3 made of the Ge-In-Sb-Te material can thus achieve higher-speed, higher-precision recording/reproduction/erasure.

The first and second dielectric layers 2, 4, and reflective layer 5 are all made of materials having high thermal conductivity, allowing swift dissipation of heat that can build up in the phase-change recording layer 3. The Ag-Nd-Cu material for the reflective layer 5 is particularly effective for the heat dissipation in the phase-change recording layer 3, contributing to the higher-speed, higher-precision recording/reproduction/erasure. Efficient heat dissipation means fast cooling after the heating to above the melting point, whereby end edges of the recording marks are made sharp. High-precision information recording is thus possible at high speed.

The geometrical structure of the grooves G, lands L, and land pre-pits LP in the lands L enables generation of high-quality reproduction signals and contributes to high-speed information reproduction. During high-speed information reproduction, signals obtained by the land pre-pits LP may interfere with RF reproduction signals obtained from the grooves G and cause errors due to noise or distortion of the RF signals. Taking this problem into account, the depth d of the grooves G is set within the range of from 25 to 50 nm, and the depth dpp of the land pre-pits LP is set plus-minus 3 nm relative to the groove depth. Adverse effects of land pre-pits LP are thereby largely reduced, so that generation of high-quality RF reproduction signals is possible even in high-speed reproduction.

By thus improving the material compositions of the phase-change recording layer 3, first and second dielectric layers 2, 3, and reflective layer 5, and by adopting a novel structure of the grooves G, lands L, and land pre-pits LP, the present invention provides a high-precision, high-speed DVD-RW disc.

### EXAMPLES

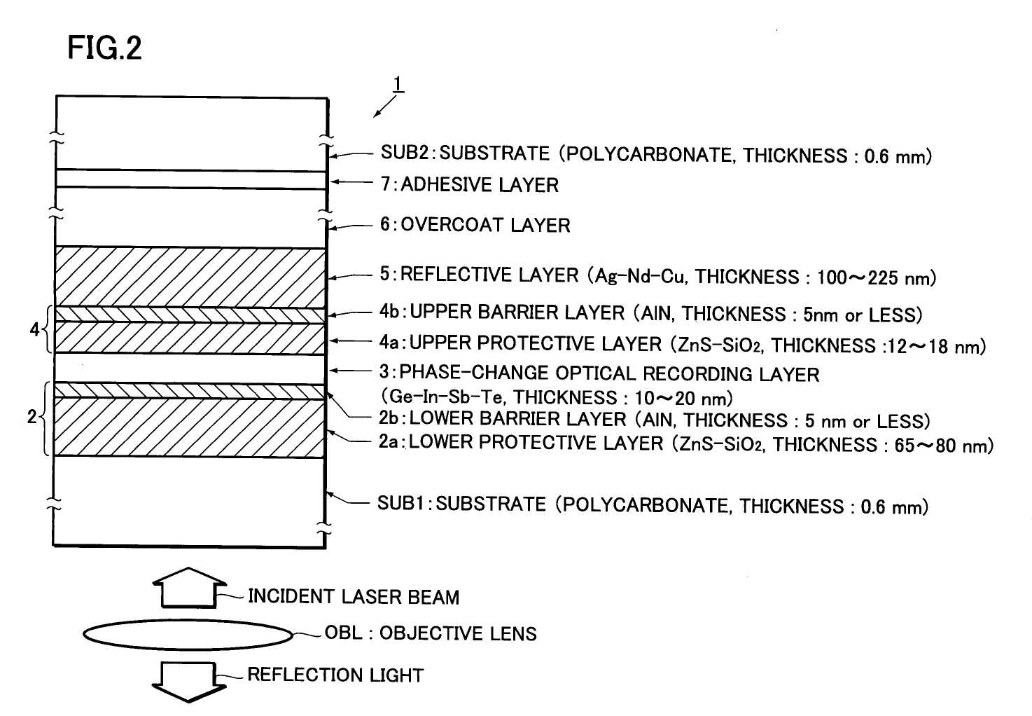

Concrete examples of the present invention will be hereinafter described with reference to FIG. 2 to FIG. 8. One example to be described is a phase-change type information storage medium that is compatible with the existing DVD-RW Version 1.1 standard and capable of high-precision, high-speed recording, reproduction, and erasing of information.

FIG. 2 is a model view showing part of the cross section of the structure of DVD-RW disc of the present example. Same reference numerals are used to denote the same or similar parts shown in FIG. 1. The land-groove structure shown in FIG. 1 is not shown in FIG. 2.

As in the embodiment shown in FIG. 1, the DVD-RW disc 1 of FIG. 2 has a first substrate SUB1 having a novel land-groove structure formed thereon. On the first substrate SUB1, a first dielectric layer 2, a phase-change recording layer 3, a second dielectric layer 4, and a reflective layer 5 are stacked in this order. Further, an overcoat layer 6 is formed on the reflective layer 5. The stacked overcoat layer 6 and a second substrate SUB2 are bonded with an adhesive layer 7, forming a sandwich structure.

The substrate SUB1 is formed of a transparent glass or resin material having a transparency of 85% or more with low optical anisotropy relative to laser beam. Resin materials that can typically be used for the substrate are thermoplastic resins such as acrylic resins, polycarbonate resins, and polyolefin resins. The substrate SUB1 has a thickness ranging from 0.57 to 0.63 mm.

The depth d of the grooves G is in the range of from 25 to 50 nm, and the width w at a depth d/2 of the grooves G is in the range of from 200 to 350 nm. The track pitch p is in the range of from 0.7 to 0.8 μm.

The land pre-pits LP in the lands L have a depth dpp ranging from −3 to 3 nm relative to the depth d of the grooves G.

The disc 1 thus constructed is rotated at an rpm ranging from 3.49 m/sec (normal speed) to 7.0 m/sec (approximately double speed) in the information read/write device. A laser beam of wavelength 600 to 700 nm is focused by an objective lens having a numerical aperture of 0.55 to 0.70, and the focused laser beam is directed to the first substrate SUB1 to achieve recording or erasing, or reproduction, of information on or from the phase-change recording layer 3.

The first dielectric layer 2 is made up of a third dielectric layer (hereinafter referred to as “lower protective layer”) 2a on the side of the substrate SUB1 and a fourth dielectric layer (hereinafter referred to as “lower barrier layer”) 2b on the side of the phase-change recording layer 3.

The lower protective layer 2a is chiefly composed of zinc sulfide (ZnS) and silicone oxide (SiO₂) and has a thickness ranging from 65 to 80 nm. More specifically, the layer material contains 80 mol % of ZnS and 20 mol % of SiO₂.

The lower barrier layer 2b is chiefly composed of one of aluminum nitride (AlN), germanium nitride (Ge₃N₄), and silicone nitride (Si₃N₄) and has a thickness of 5 nm or less. The example shown in FIG. 2 uses AlN.

The thickness of the lower protective layer 2a and lower barrier layer 2b is set within the above ranges so that the overall thickness of the first dielectric layer 2 is within the range of from 65 to 85 nm.

The phase-change recording layer 3 is made of a Ge-In-Sb-Te material and has a thickness of 10 to 20 nm. The atomic proportions of the elements are as follows:

Ge+In+Sb+Te=100 atom %

3 atom %≦Ge≦5.5 atom %

3 atom %≦In≦5.5 atom %

68.5 atom %<Sb<72 atom %

20 atom %<Te<23.5 atom %.

The second dielectric layer 4 is made up of a fifth dielectric layer (hereinafter referred to as “upper protective layer”) 4a on the side of the phase-change recording layer 3 and a sixth dielectric layer 4b (hereinafter referred to as “upper barrier layer”) laminated thereon on the side of the reflective layer 5.

The upper protective layer 4a is chiefly composed of ZnS and SiO₂ and has a thickness ranging from 12 to 18 nm. More specifically, the layer material contains 80 mol % of ZnS and 20 mol % of SiO₂.

The upper barrier layer 4b is chiefly composed of one of AlN, Ge₃N₄, and Si₃N₄, and has a thickness of 5 nm or less.

The example shown in FIG. 2 uses AlN.

The thickness of the upper protective layer 4a and upper barrier layer 4b is set within the above ranges so that the overall thickness of the second dielectric layer 4 is within the range of from 13 to 23 nm.

The reflective layer 5 is made of an Ag-Nd-Cu metal material and has a thickness of 100 to 225 nm. The atomic proportions of the elements are as follows:

Ag+Nd+Cu=100 atom %

0.3 atom %≦Nd≦0.8 atom %

0.5 atom %≦Cu≦1.0 atom %.

The overcoat layer 6 is formed of UV-setting resin and has a thickness of about 1 to 250 μm.

The adhesive for the adhesive layer 7 is, e.g., a UV-setting, organic material.

The second substrate SUB2 is formed of a thermoplastic resin such as an acrylic, polycarbonate, or polyolefin resin, as that for the first substrate SUB1, and has a thickness of about 0.6 mm. Polyolefin resin is used in this embodiment.

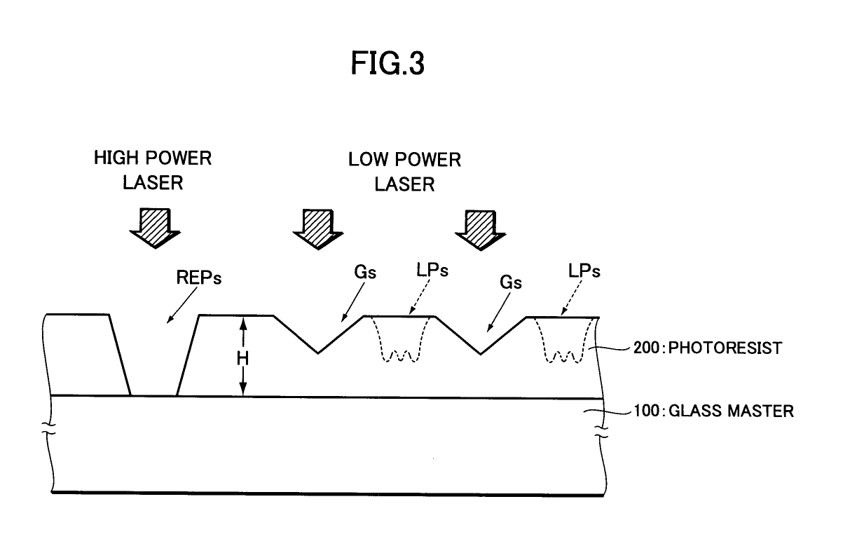

The DVD-RW disc 1 is fabricated as described below with reference to FIG. 3.

First, positive photoresist 200 is applied on a glass master 100 to a preset thickness H by spin-coating, which is then baked and exposed to laser light.

The laser beam intensity is controlled so as to form a latent image of emboss portions REPs, groove portions Gs, and land pre-pit portions LPs corresponding to readable emboss pits, grooves G, and land pre-pits LP, respectively. The photoresist 200 is then developed using a suitable developing agent to remove the exposed portions of the photoresist 200 or the latent image, to obtain a master disc having such a cross section as shown in the drawing.

The exposure of the emboss portions REPs is performed with a high laser beam intensity so that the glass face of the glass master 100 is exposed to the laser beam, while it is performed with a lower laser beam for the groove portions Gs so that the glass face of the glass master 100 is not exposed to the laser beam, thereby providing the emboss portions REPs having a U-shaped cross section and the groove portions Gs having a V-shaped cross section as shown in the drawing.

The next step is to create a nickel stamper from this master disc using an electroforming process.

The first substrate SUB1 is then fabricated by an injection molding process of, for example, polycarbonate resin, using this stamper so as to transfer the readable emboss pits, grooves G, lands L, and land pre-pits LP onto one side of the substrate.

The lower protective layer 2a and barrier layer 2b, phase-change recording layer 3, upper protective layer 4a and barrier layer 4b, and reflective layer 5 are then successively laminated by spattering processes on the side of the first substrate SUB1 where the land-groove structure has been formed. Finally, the overcoat layer 6 of UV-setting resin is formed by spin-coating on the reflective layer 5, and the second substrate SUB2 is bonded thereon with the adhesive layer 7 therebetween, to form the DVD-RW disc 1.

According to the DVD-RW disc 1 of the example having such a configuration, the following effects are achieved:

[Effects Based on the Novel Structure and Composition]

High crystallization speed or good crystallizability of the phase-change recording layer 3 is essential to achieve high-speed recording, because if the speed is low, some recording marks may remain uncrystallized.

Fast dissipation of heat that can build up in the phase-change recording layer 3 is also important for the stabilization of the amorphous recording marks. Higher heat dissipation speed will result in sharper end edges of the recording marks. Thus the speed of crystallization and the speed of heat dissipation are key elements for achieving high-speed recording.

The Ge-In-Sb-Te material used for the phase-change recording layer 3 in this invention increases the crystallization speed, thus enabling the high-speed recording.

In addition to high crystallization speed, the Ge-In-Sb-Te material has the merit of being relatively stable in both crystalline and amorphous states even when it has a composition that will demonstrate high erasability. With the above-specified proportion of each element of the material, the phase-change recording layer 3 can form crystalline and amorphous phases ideal for high-speed recording.

Faster heat dissipation of the phase-change recording layer 3 is achieved by the Ag-Nd-Cu material used for the reflective layer 5; because of the material's high thermal conductivity, heat that builds up in the phase-change recording layer 3 particularly during recording is dissipated more efficiently, contributing to high-quality, high-speed recording. The above-specified proportion of each element of the Ag-Nd-Cu material ensures excellent heat dissipation effect.

The lower barrier layer 2b and upper barrier layer 4b of the first and second dielectric layers 2, 4 improve corrosion resistance and Direct Over Write (DOW) characteristics.

If the second dielectric layer 4 were solely made of the upper protective layer 4a chiefly consisting of ZnS-SiO₂, improvement of the corrosion resistance would then be harder because of a chemical reaction between sulfur contained in the layer 4 and silver contained in the directly adjacent reflective layer 5 of Ag-Nd-Cu material, which generates silver sulfide.

The invention achieves improvement of the corrosion resistance by forming the upper protective layer 4a chiefly made of ZnS and SiO₂ and the upper barrier layer 4b made of one of AlN, Ge₃N₄, and Si₃N₄, and further interposing the upper barrier layer 4b between the upper protective layer 4a and the reflective layer 5. Thus enhancement of heat dissipation effect and improvement of corrosion resistance are both attained.

Furthermore, the lamination structure of the first dielectric layer 2 with the lower protective layer 2a and barrier layer 2b, the latter being interposed between the former and the phase-change recording layer 3, can extend the power margin, whereby the DOW characteristics are improved.

[Effects Based on the Fabrication Method and the Readable Emboss-Groove Structure]

DVD-RW disc with readable emboss system needs to be formed with readable embosses and grooves at different depths on the substrate.

With the above fabrication method, the readable embosses are formed to have a U-shaped cross section, while the grooves have a V-shaped cross section.

For proper reproduction of information with the readable emboss system in an information read/write device such as a DVD player, the modulation must be at least 60% of the standard value. Also, for the push/pull tracking during recording of information in a DVD recorder or the like, the level of the push/pull signal obtained from the readable emboss needs to be within the range of from 0.22 to 0.44 of the standard value before recording.

In this embodiment, the depth of the U-shaped readable embosses is set within the range of from 60 to 85 nm, while the V-shaped grooves G have a depth d of 25 to 50 nm and a width w of 200 to 350 nm. This configuration ensures proper reproduction of information from the readable embosses at high speed, and enables sufficient push/pull signal to be obtained from the V-shaped grooves G, thereby securing the compatibility of the disc with the DVD-RW Version 1.1 standard.

[Effects Based on the Novel Configuration of the Land Pre-Pits]

According to the DVD-RW Version 1.1 standard, when recording information in the grooves G as recording marks, the land pre-pits LP provide pre-address information, disc code and other information and play an important roll.

Depending on the shape of the land pre-pits LP, the land pre-pit signal may leak into the recording/reproduction signal, causing noise or distortion in the RF reproduction signal. While such problem may not arise in normal speed recording, it may become evident in double speed recording depending on the shape of the land pre-pits LP, resulting in deterioration of reproduction quality.

In this embodiment, the present inventors have given much attention to the relation between the shape and depth dpp of the land pre-pits LP and the depth d of the grooves G, and the depth d of the grooves G is set within the range of from 25 to 50 nm, while the depth dpp of the land pre-pits LP is set within the range of plus-minus 3 nm relative to the groove depth d, whereby deterioration of reproduction quality resulting from the land pre-pits LP is prevented.

FIG. 4A to FIG. 7 show the test results for establishing the effects of optimization of the shape and geometry of the land pre-pits LP.

FIG. 4A is a microscope image of the land-groove structure of the DVD-RW disc 1, showing a cross section of the grooves G, lands L, and land pre-pits LP.

FIG. 4B is a cross-sectional view obtained by tracing the image of FIG. 4A. The contour of the grooves G, lands L, and land pre-pits LP is drawn in particular, so as to give a clear view of the structure.

FIG. 4C is a model diagram of the top view of the substrate SUB1 on which are formed the grooves G, lands L, and land pre-pits LP, of the portion shown in FIG. 4A and FIG. 4B. Note, the groove wobble is not shown for ease of description.

FIG. 4A and FIG. 4B illustrate the cross section along the imaginary line A-A passing through a land pre-pit LP in the land L of FIG. 4C.

As can be seen from FIGS. 4A to 4C, land pre-pits LP are formed in the lands L, but have an independent structure for fulfilling a different function from that of the lands L.

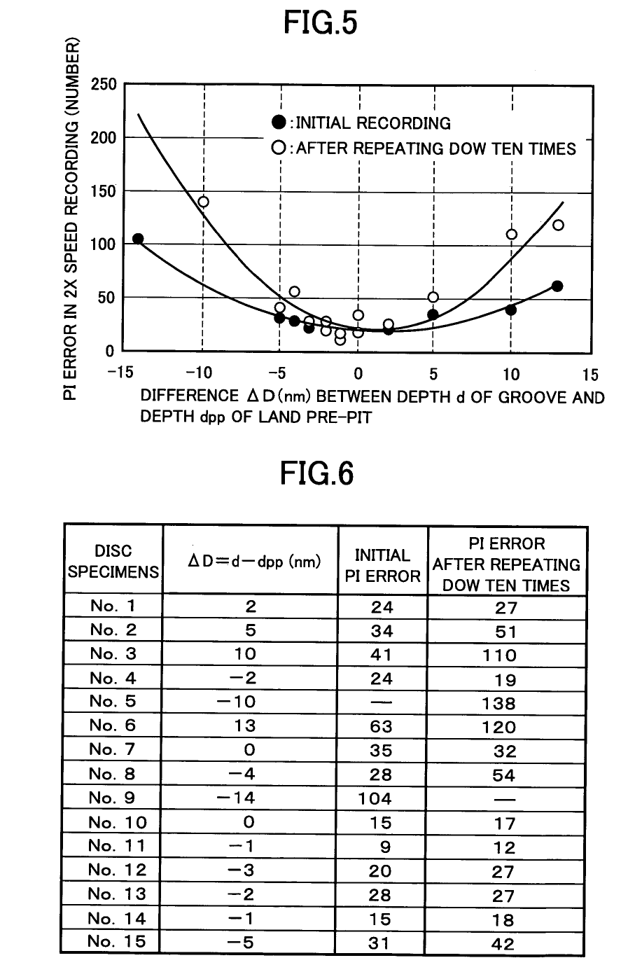

Test specimens of DVD-RW discs 1 having different depths d of the grooves G and depths dpp of the land pre-pits LP were prepared, and the number of inner parity errors per 8ECC block (PI error) during double speed reading and writing was measured. FIG. 5 shows the plot of PI error relative to the difference ΔD between the depth d and dpp. The white circles show the measurement result of the number of PI errors in the disc specimens at the initial recording, and the black circles show the measurement result of the number of PI errors after repeating DOW ten times.

FIG. 6 is a table showing each value ΔD of the difference d−dpp of No. 1 to No. 15 disc specimens, and the number of PI errors measured at the initial recording and after repeating DOW ten times.

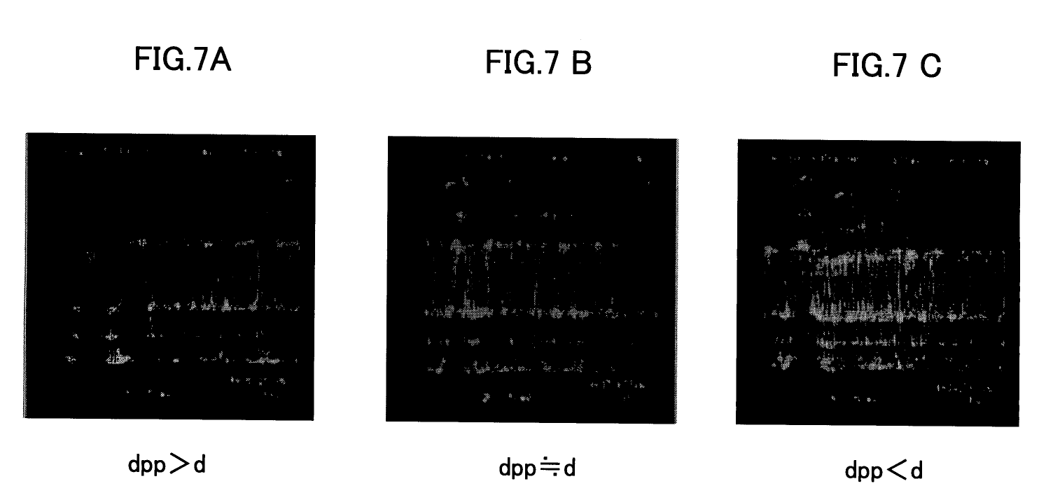

FIGS. 7A to 7C are waveform images of the RF reproduction signal obtained after repeating DOW a thousand times with respect to three disc specimens having different ΔD values. FIG. 7A shows the case where the difference ΔD is a negative value larger than −3 nm, FIG. 7B shows the case where the difference AD is 0 nm, and FIG. 7C shows the case where the difference AD is a positive value larger than 3 nm.

The DVD-RW disc 1 has the land-groove structure with grooves G, lands L, and land pre-pits LP between the grooves G, as shown in FIG. 4.

FIG. 5 and FIG. 6 show the measurement results for ascertaining how the number of PI errors changes in accordance with the difference AD between the depth d of the grooves G and depth dpp of the land pre-pits LP.

As is seen from FIG. 5 and FIG. 6, it was confirmed that too shallow or too deep a depth dpp of the land pre-pits LP relative to the groove depth d resulted in large numbers of PI errors at the initial recording and even larger numbers of PI errors after repeating DOW ten times.

Furthermore, an examination of the RF reproduction signal after repeating DOW a thousand times shows that waveform distortion occurs on the minus side when the depth dpp of the land pre-pits LP is deeper than the depth d of the grooves G (dpp>d) as shown in FIG. 7A and on the plus side when the depth dpp of the land pre-pits LP is shallower than the depth d of the grooves G (dpp<d) as shown in FIG. 7C, resulting in the increased numbers of PI errors.

On the other hand, when the depth dpp of the land pre-pits LP and depth d of the grooves G is substantially the same (dpp≈d), no waveform distortion was observed, as shown in FIG. 7B.

The test results shown in FIG. 5 and FIG. 6 therefore indicate that it is preferable to set the depth dpp and depth d substantially the same, and the permissible range of deviation of the depth dpp relative to the depth d is plus-minus 3 nm.

The significance of setting the depth dpp of the land pre-pits LP relative to the depth d of the grooves G within the range of plus-minus 3 nm was thus confirmed.

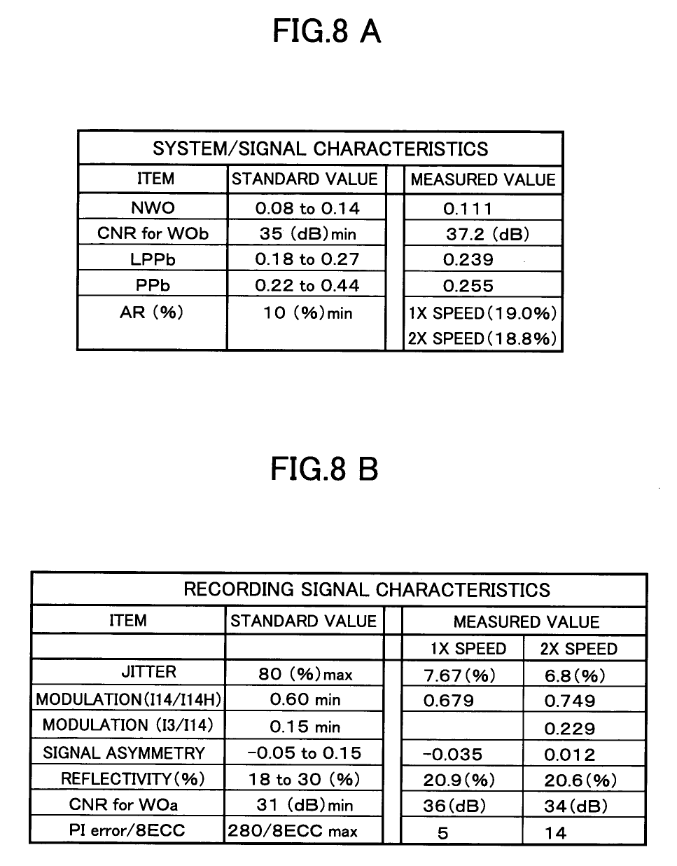

FIGS. 8A and 8B show an overall evaluation of the DVD-RW disc 1 of the invention having the novel structure.

FIG. 8A shows the measured values of the disc 1 of the invention with respect to various features of system/signal characteristics in comparison with the standard values specified in the DVD-RW Version 1.1 standard. FIG. 8B shows the measured values with respect to various features of recording signal characteristics in comparison with the standard values specified in the DVD-RW Version 1.1 standard.

The standard values in FIGS. 8A and 8B are in the case of normal speed recording, while the measured values are given in both cases of normal speed and double speed recording.

The measurement was made with laser beam power control in accordance with the basic light strategy and double speed optimizing strategy of the DVD-RW Version 1.1 standard.

The acronyms in FIGS. 8A and 8B represent the following:

NOW: Normalized wobble signal (normalized reproduction wobble signal amplitude),

CNR of WOb: CN ratio of wobble signal (WO) before recording,

LPPb: Reproduction signal level of land pre-pits (LP) before recording,

PPb: Push/pull (PP) signal level before recording,

AR: Aperture rate of eye pattern in land pre-pits (LP) after recording,

CNR of WOa: CN ratio of reproduction wobble signal after recording,

PI error/8ECC: Number of PI errors per 8ECC block.

As can be seen from the tables in FIGS. 8A and 8B, the DVD-RW disc 1 of this invention satisfies the various requirements specified by the DVD-RW Version 1.1 standard in both normal and double speed recording and thus is capable of high-precision, high-speed recording/reproduction of information.

According to the present invention, high-precision, high-speed recording/reproduction is achieved by improvement of the characteristics of the phase-change recording layer 3 and reflective layer 5, optimization of the depth of the grooves G and land pre-pits LP, and provision of the barrier layers 2b and 4b.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. An information storage medium comprising:
a substrate having grooves, lands formed between the grooves, and land pre-pits formed in the lands, the grooves, the lands, and the land pre-pits being formed on one side thereof;
a first dielectric layer, a phase-change recording layer, a second dielectric layer, and a reflective layer formed in this order on said one side of the substrate, the information storage medium being rotated at a linear speed ranging from 3.49 to 7.0 m/sec while said phase-change recording layer in said grooves is irradiated with a 600 to 700 nm wavelength laser beam through an objective lens having a numerical aperture ranging from 0.55 to 0.7, thereby effecting information recording and reproduction, wherein
said phase-change recording layer is made of a Ge-In-Sb-Te material, and said reflective layer is made of an Ag-Nd-Cu material;
said first dielectric layer has a thickness ranging from 65 to 85 nm, said phase-change recording layer has a thickness ranging from 10 to 20 nm, said second dielectric layer has a thickness ranging from 13 to 23 nm, and said reflective layer has a thickness ranging from 100 to 225 nm; and
said grooves have a width ranging from 200 to 350 nm and a depth ranging from 25 to 50 nm, and said land pre-pits have a depth in a range of plus-minus 3 nm relative to the depth of said grooves.

2. The information storage medium according to claim 1, wherein
said grooves are formed in a meandering pattern in a constant cycle and have a track pitch in a range of from 0.7 to 0.8 μm.

3. The information storage medium according to claim 1, wherein
said Ge-In-Sb-Te material forming said phase-change recording layer is composed of 3 to 5.5 atom % of germanium, 3 to 5.5 atom % of indium, 68.5 to 72 atom % antimony, and 20 to 23.5 atom % of tellurium.

4. The information storage medium according to claim 1, wherein
said Ag-Nd-Cu material forming said reflective layer comprises 0.3 to 0.8 atom % of neodymium, and 0.5 to 1.0 atom % of copper.

5. The information storage medium according to claim 1, wherein
said first dielectric layer includes a third dielectric layer on the side of said substrate and a fourth dielectric layer on the side of said phase-change recording layer,
said third dielectric layer being chiefly composed of silicone oxide and zinc sulfide and having a thickness ranging from 65 to 80 nm, and
said fourth dielectric layer being chiefly composed of one of aluminum nitride, germanium nitride, and silicone nitride and having a thickness of 5 nm or less.

6. The information storage medium according to claim 1, wherein
said second dielectric layer includes a fifth dielectric layer on the side of said phase-change recording layer and a sixth dielectric layer on the side of said reflective layer,
said fifth dielectric layer being chiefly composed of silicone oxide and zinc sulfide and having a thickness ranging from 12 to 18 nm, and
said sixth dielectric layer being chiefly composed of one of aluminum nitride, germanium nitride, and silicone nitride and having a thickness of 5 nm or less.
